(19) United States
(12) Patent Application Publication
(10) Pub. No.: US 2026/0039448 A1
(43) Pub. Date: Feb. 5, 2026

(54) ARCHITECTURE FOR DUAL CHANNEL AMPLIFIER ISOLATION

(71) Applicant: Samsung Electronics Co., Ltd., Suwon-si (KR)

(72) Inventors: Xinguang Xu, Allen, TX (US); Shenggang Dong, Dallas, TX (US); Gang Xu, Allen, TX (US); Won Suk Choi, McKinney, TX (US)

(21) Appl. No.: 19/193,862

(22) Filed: Apr. 29, 2025

Related U.S. Application Data
(60) Provisional application No. 63/679,482, filed on Aug. 5, 2024.

(51) Int. Cl. H04L 5/14; H04B 1/40

(52) U.S. Cl. CPC H04L 5/1461; H04B 1/40

(57) ABSTRACT

Methods and systems for dual channel amplifier isolation. A transceiver system includes a first antenna configured to transmit and receive radio frequency (RF) signals from a base station (BS), a second antenna configured to transmit and receive RF signals from a user equipment (UE), a processor configured to control an operating mode of the transceiver system, a first transceiver configured for time division duplexing (TDD) operatively coupled to the processor and a second transceiver configured for frequency division duplexing (FDD) operatively coupled to the processor. The first transceiver includes a first TDD amplifier stage, and a first TDD switch. The second transceiver includes a first FDD amplifier stage, and a first FDD duplexer.

### CROSS-REFERENCE TO RELATED APPLICATIONS AND CLAIM OF PRIORITY

The present application claims priority to U.S. Provisional Patent Application No. 63/679,482, filed on Aug. 5, 2024. The contents of the above-identified patent documents are incorporated herein by reference.

### TECHNICAL FIELD

The present disclosure relates generally to wireless communication systems. more specifically, the present disclosure relates to a system and method for dual channel amplifier isolation.

### BACKGROUND

Fixed wireless access (FWA) services are being deployed as an alternative to fiber installations for home internet. In FWA, the customer premise equipment (CPE) is connected to the base station (BS) by wireless radio waves instead of fiber-optic cables, which is more suitable for areas where wired infrastructure is limited or costly to deploy. C-band (4-8 GHz) or 5G FR2 mmWave bands are expected to be utilized at first to support FWA services. However, both frequency bands suffer high path loss compared to lower frequency bands, which can limit the FWA node range of coverage.

Wireless and wireline communication systems use components, such as repeaters within base stations and handsets, to overcome excessive path loss while receiving, amplifying, and transmitting uplink and downlink signals without signal quality degradation. However, these components may break channel reciprocity in 5G Time Division Duplex (TDD) and Frequency Division Duplex (FDD) systems. Accordingly, there is a need for systems and methods for improved isolation between channels of amplifier systems that overcome these challenges.

### SUMMARY

The present disclosure relates generally to wireless communication systems and, more specifically, the present disclosure relates to a system and method for isolation between dual channels of an amplifier system.

In one embodiment, a transceiver system is provided. The transceiver system includes a first antenna configured to transmit and receive radio frequency (RF) signals from a base station (BS), a second antenna configured to transmit and receive RF signals from a user equipment (UE), a processor configured to control an operating mode of the transceiver system, a first transceiver configured for time division duplexing (TDD) operatively coupled to the processor and a second transceiver configured for frequency division duplexing (FDD) operatively coupled to the processor. The first transceiver includes a first TDD amplifier stage, and a first TDD switch. The second transceiver includes a first FDD amplifier stage, and a first FDD duplexer.

In another embodiment, a method is provided. The method includes controlling a first TDD switch and a first FDD duplexer to operate a transceiver system in a transmitter operating mode or in a receiver operating mode. The transceiver system includes a first antenna, a second antenna, a processor configured to control an operating mode of the transceiver system, a first transceiver configured for time division duplexing (TDD) operatively coupled to the processor and a second transceiver configured for frequency division duplexing (FDD) operatively coupled to the processor. The first transceiver including a first TDD amplifier stage and the first TDD switch. The second transceiver including a first FDD amplifier stage and the first FDD duplexer. The method also includes receiving or transmitting RF signals.

In yet another embodiment, a non-transitory computer-readable medium is provided. The non-transitory computer-readable medium includes program code, that when executed by at least one processor of an electronic device, causes the electronic device to control a first TDD switch and a first FDD duplexer to operate a transceiver system of the electronic device in a transmitter operating mode or in a receiver operating mode. The transceiver system includes a first antenna, a second antenna, a first transceiver configured for time division duplexing (TDD) and a second transceiver configured for frequency division duplexing (FDD). The second transceiver includes a first FDD amplifier stage and the first FDD duplexer. The program code further includes program code, that when executed by at least one processor of an electronic device, causes the electronic device to receive or transmit RF signals.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit”, “receive”, and “communicate”, as well as derivatives thereof, encompass both direct and indirect communication. The terms “include” and “comprise”, as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4 illustrates an example of time division duplexing according to embodiments of the present disclosure;

FIG. 5 illustrates an example of time division duplexing according to embodiments of the present disclosure;

FIG. 6 illustrates an example wireless network including a transceiver according to embodiments of the present disclosure;

FIG. 7 illustrates an example transceiver according to embodiments of the present disclosure;

FIGS. 8A-8B illustrate example wireless transceiver architectures according to embodiments of the present disclosure;

FIGS. 9A-9B illustrate example cascade wireless transceiver architectures according to embodiments of the present disclosure; and

FIGS. 10A-10B illustrate example methods for operating a transceiver according to embodiments of the present disclosure.

### DETAILED DESCRIPTION

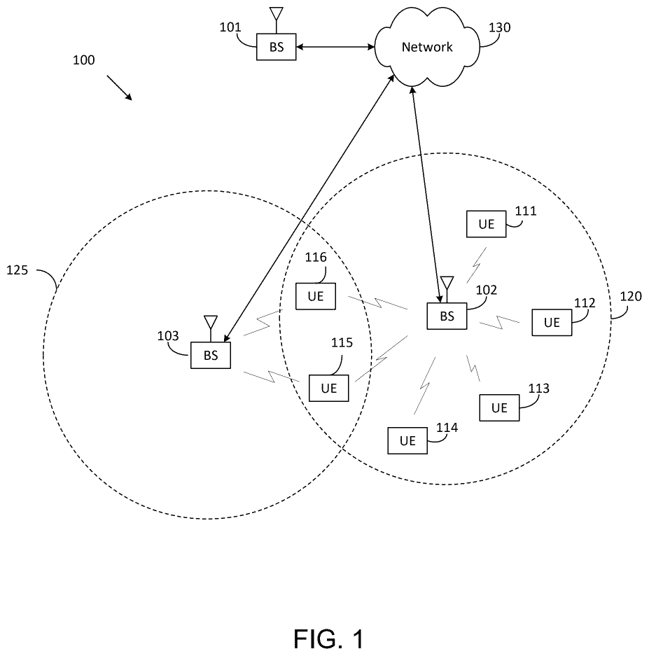

FIG. 1 through FIG. 10B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

As introduced above, fixed wireless access (FWA) services use auxiliary devices, such as auxiliary devices may include repeaters, boosters, extenders, and backhauls, to extend the distance between a base transceiver station (BTS) and a customer premise equipment (CPE) and build data link between BTS and BTS, CPE and CPE. However, these auxiliary devices adopt different amplifier chain architectures for uplinks and downlinks, breaking the channel, disrupting time division duplex (TDD) and frequency division duplex (FDD) systems. For example, the amplifier gains in the auxiliary device conflicts with the switch isolation in the TDD systems and with duplex isolation in FDD systems. Additionally, the isolation in the auxiliary device of the switch and the duplex limits the gain of amplifiers.

For example, in a transmitting mode, the signal received from base station is amplified by a low noise amplifier (LNA) then by a power amplifier (PA), which optimizes power transfer and power added efficiency. A variable gain amplifier (VGA) may be inserted between the LNA and PA to tune the gain. The repeated signal, which is several orders higher at the output of PA is transmitted to a user equipment (UE) through an antenna.

In general, the receiving amplifier only amplifies the receiving signal, but an RF switch and a frequency duplexer do not isolate transmitting signal leakage to receiving amplifier where the received (uplink) signal is mixed with transmitted (downlink) signal. Similarly, the received signal leakage to transmitting amplifier is not isolated and results in signal mixing.

When the leakage signal is more than the transmission signal, or the gain of the amplifiers exceeds isolation capabilities of RF switches or frequency duplexers used, the uplink or downlink signal have high or degraded signal-to-noise ratios (SNRs) and the system becomes stable due to self-oscillation that occurs.

To get a decent SNR in an amplifier chain, the isolation of switch or duplex should be more than the gain of amplifiers as much as possible.

Accordingly, the present disclosure provides systems and methods for isolating amplifier gain within a transceiver system configured for TDD and FDD using separate TDD and FDD chains isolated using TDD switches and FDD duplexers, respectively. In particular, the present disclosure provides a diversified isolation of switches, duplexers, and gain of amplifiers based on multiple receiving (e.g., uplink) and transmitting (e.g., downlink) amplifiers chains or stages, where each amplifier stage includes an LNA, a PA, and at least one of two RF SPDT switches, one DPDT switch, or two duplexes.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station”, “subscriber station”, “remote terminal”, “wireless terminal”, “receive point”, “customer premise equipment (CPE)”, or “user device”. For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for wireless communication in a wireless communication system with a reciprocal wireless transceiver for dual channel amplifier isolation. In certain embodiments, one or more of the gNBs 101-103 includes circuitry, programing, or a combination thereof, to support communication in a wireless communication system with a reciprocal wireless transceiver for dual channel amplifier isolation.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

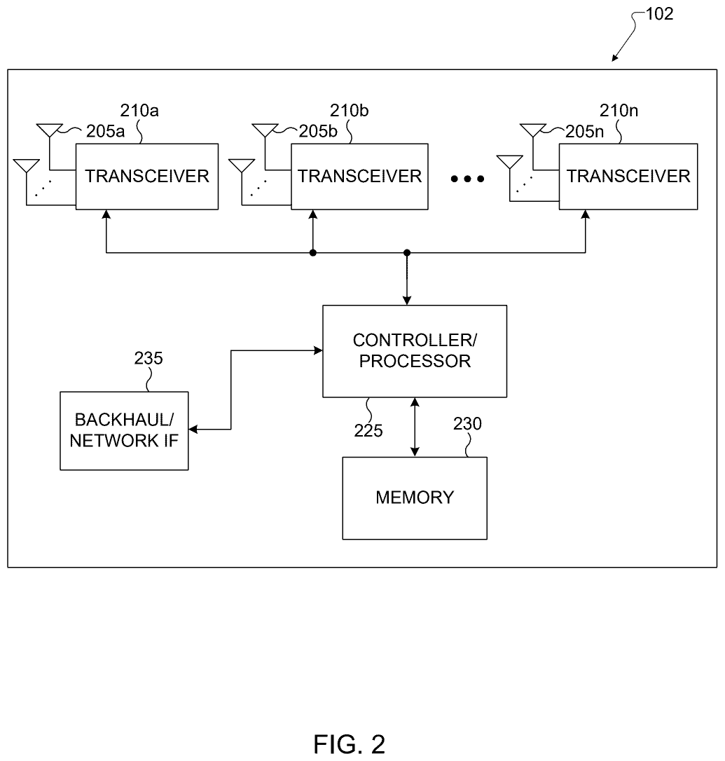

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS and, for example, processes to support communication in a wireless communication system with a reciprocal wireless transceiver for dual channel amplifier isolation as discussed in greater detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

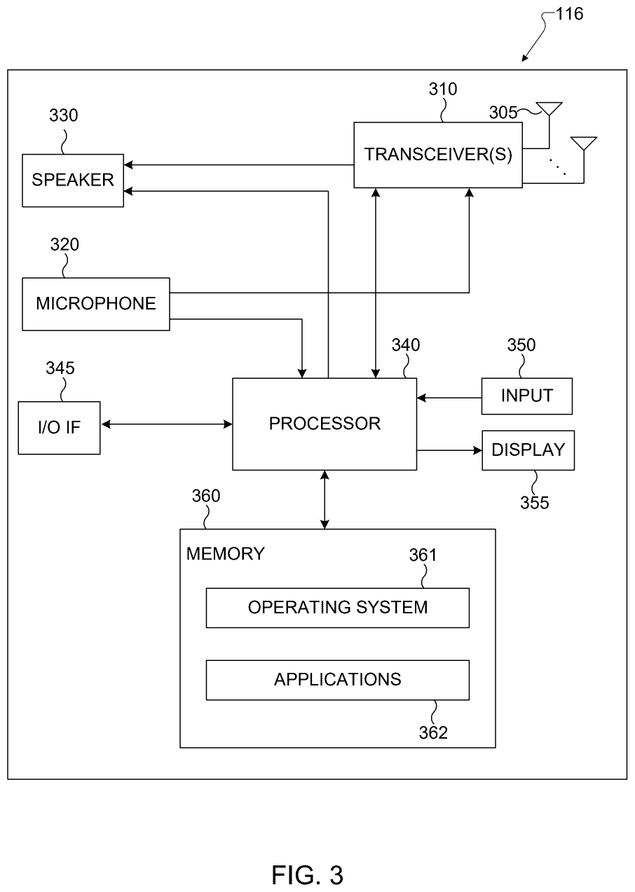

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for communication in a wireless communication system with a reciprocal wireless transceiver for dual channel amplifier isolation as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of a UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

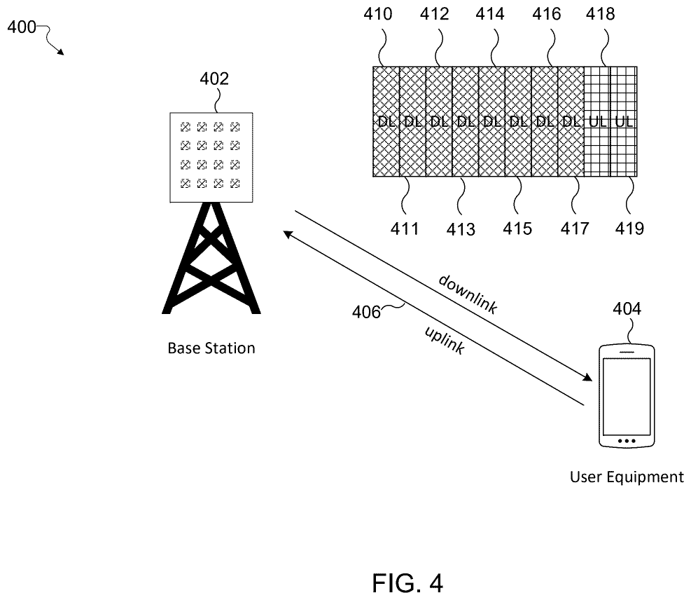

In some wireless networks, for example wireless networks providing fixed wireless access (FWA) services, a Time Division Duplex (TDD) system is employed that utilizes time division multiplexing of the downlink (DL) and uplink (UL) traffic of multiple users through separate time slots as shown in FIG. 4.

FIG. 4 illustrates an example of time division duplexing 400 according to embodiments of the present disclosure. The embodiment of time division multiplexing of FIG. 4 is for illustration only. Different embodiments of time division multiplexing could be used without departing from the scope of this disclosure.

In the example of FIG. 4, a base station (BS) 402 and a user equipment (UE) 404 are communicating over a communications channel 406 according to a time division multiplexing (TDM) scheme. The TDM scheme of FIG. 4 includes a plurality of time slots 410-419. The time slots 410-417 are assigned to downlink communication, and the time slots 418 and 419 are assigned to uplink communication. During the times slots 410-417, the BS 402 may transmit on the communication channel 406, and the transmissions may be received by the UE 404. During the time slots 418-419, the UE 404 may transmit on the communication channel 406, and the transmissions may be received by the BS 402.

Although FIG. 4 illustrates an example time division duplexing 400, various changes may be made to FIG. 4. For example, various changes to time slot assignments could be made and additional UEs may utilize the communication channel according to particular needs.

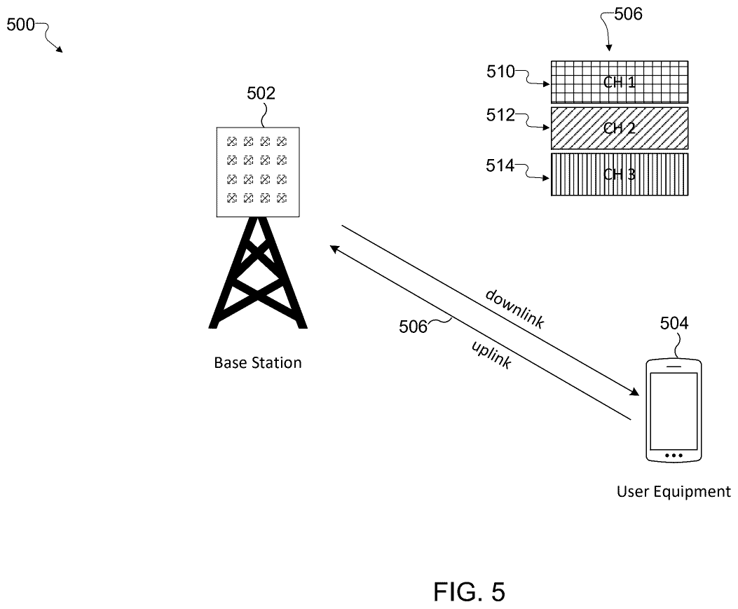

FIG. 5 illustrates an example of frequency division duplexing 500 according to embodiments of the present disclosure. The embodiment of frequency division multiplexing of FIG. 5 is for illustration only. Different embodiments of frequency division multiplexing could be used without departing from the scope of this disclosure.

As shown in FIG. 5, a base transceiver station (BTS) 502 and a user equipment (UE) 504 are communicating over a communications channel 506 according to a frequency division multiplexing (FDM) scheme. The FDM scheme of FIG. 5 includes a plurality of frequency bands 510-514. For example, the frequency bands 510 and 514 are assigned to downlink communication and the frequency band 512 is assigned to uplink communication. The BTS 502 may transmit RF signals on the frequency bands 510 and 514, and the RF signals may be received by the UE 504. Additionally, the UE 504 may transmit RF signals on the frequency band 512, and the RF signals may be received by the BTS 502.

Although FIG. 5 illustrates an example frequency division duplexing 500, various changes may be made to FIG. 5. For example, various changes to frequency band assignments could be made and additional UEs may utilize the communication channel according to particular needs.

In some wireless networks, such as wireless networks providing fixed wireless access (FWA) services, a signal transceiver may be employed to boost the node coverage of a BTS. The signal transceivers are used in wireless and wireline communication systems to overcome excessive path loss. The main function of a signal transceiver is to receive, amplify, and retransmit an uplink or downlink signal without signal quality degradation. In the present disclosure, a signal transceiver may also be referred to as a wireless transceiver or a transceiver.

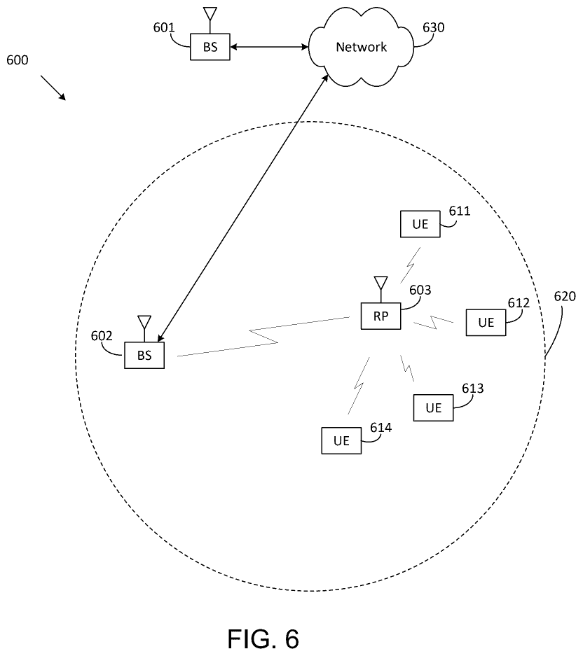

FIG. 6 illustrates an example wireless network 600 including a transceiver according to embodiments of the present disclosure. The embodiment of the wireless network 600 shown in FIG. 6 is for illustration only. Other embodiments of the wireless network 600 could be used without departing from the scope of this disclosure.

As shown in FIG. 6, the wireless network includes a gNB 601 (e.g., base station, BS), a gNB 602, and a transceiver 603. The gNB 601 communicates with the gNB 602. The gNB 601 also communicates with at least one network 630, such as the Internet, a proprietary Internet Protocol (IP) network, or other data network.

The gNB 602 provides wireless broadband access to the network 630 for a plurality of user equipments (UEs) within a coverage area 620 of the gNB 602. The plurality of UEs includes a UE 611, 612, 613, and 614 which may be located in a home or small business with a poor line of site to gNB 602. To improve communication with UEs 611-614, transceiver 603 may be located in near the homes or the small business where the UEs 611-614 are operating and may relay signals between the gNB 602 and the UEs 611-614. For example, the transceiver 603 may be a repeater, a smart repeater, or a relay station. In some embodiments, one or more of the gNBs 601-602 and transceiver 603 may communicate with each other and with the UEs 611-614 using 5G/NR, long term evolution (LTE), long term evolution-advanced (LTE-A), WiMAX, WiFi, or other wireless communication techniques. In some embodiments, one or more of the gNBs 601-602 and transceiver 603 may communicate with each other and with the UEs 611-614 using time division duplexing, similar as described regarding FIG. 4.

Dotted lines show the approximate extents of the coverage area 620 a which is shown as approximately circular for the purposes of illustration and explanation only. It should be clearly understood that the coverage areas associated with gNBs, such as the coverage area 620 may have other shapes, including irregular shapes, depending upon the configuration of the gNBs and variations in the radio environment associated with natural and man-made obstructions.

Similar as previously described regarding the UEs 111-116 of FIG. 1, one or more of the UEs 611-614 include circuitry, programing, or a combination thereof, for communication in a wireless communication system with a reciprocal wireless transceiver for dual channel amplifier isolation. In certain embodiments, one or more of the gNBs 601-602 and the transceiver 603 includes circuitry, programing, or a combination thereof, to support communication in a wireless communication system with a reciprocal wireless transceiver for dual channel amplifier isolation similar as previously described.

Although FIG. 6 illustrates one example of a wireless network 600, various changes may be made to FIG. 6. For example, the wireless network could include any number of gNBs, any number of transceivers, and any number of UEs in any suitable arrangement. Also, the gNB 601 could communicate directly with any number of UEs and provide those UEs with wireless broadband access to the network 630. Similarly, the gNB 602 could communicate directly with the network 630 and provide the UEs with direct wireless broadband access to the network 630. Further, the gNBs 601 and 602 could provide access to other or additional external networks, such as external telephone networks or other types of data networks.

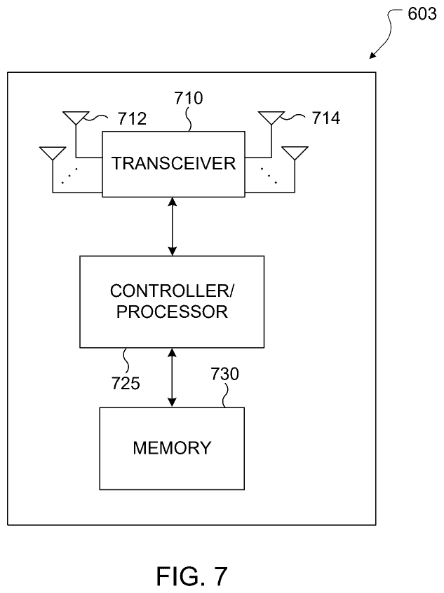

FIG. 7 illustrates an example transceiver 603 according to embodiments of the present disclosure. The embodiment of the transceiver illustrated in FIG. 7 is for illustration only, other transceivers could have the same or similar configuration. However, transceivers come in a wide variety of configurations, and FIG. 7 does not limit the scope of this disclosure to any particular implementation of a transceiver.

As shown in FIG. 7, the transceiver 603 includes a transceiver 710, antennas 712 and 714, a controller/processor 725, and a memory 730.

Transceiver 710 receives from the antennas 712 and 714, incoming RF signals, such as signals transmitted by gNB 602 and UEs in the wireless network 600. Transceiver 710 down-converts the incoming RF signals to generate IF or baseband signals. The IF or baseband signals are processed by receive (RX) processing circuitry in the transceivers 710 and/or the controller/processor 725, which generates processed baseband signals by filtering, and/or digitizing the baseband or IF signals. The controller/processor 725 may further process the baseband signals. In some embodiments, transceiver 710 may include one or more amplifier stages. An amplifier stage may include a single amplifier, an amplifier group, an amplifier set, an amplifier chain, and/or the like.

The antennas 712 and 714 may configured for communication with particular devices within a wireless network. For example, in some embodiments, the antenna 712 may be configured to transmit to and receive from the gNB 602, while the antenna 714 may be configured to transmit to and receive from the UEs in the wireless network 600. While the antennas 712 and 714 are described as individual antennas, it should be understood that the antenna 712 and/or 714 may comprise more than one antenna, an array of multiple antennas, etc.

TX processing circuitry in transceiver 710 and/or controller/processor 725 receives analog or digital data (such as voice data, web data, e-mail, or interactive video game data) from the controller/processor 725. The TX processing circuitry multiplexes, and/or digitizes the outgoing baseband data to generate processed baseband or IF signals. Transceiver 710 up-converts the baseband or IF signals to RF signals that are transmitted via the antennas 712 and 714.

The controller/processor 725 can include one or more processors or other processing devices that control the overall operation of the transceiver 603. For example, the controller/processor 725 could control the reception of UL channel signals and the transmission of DL channel signals by transceiver 710 in accordance with well-known principles. The controller/processor 725 could support additional functions as well, such as more advanced wireless communication functions. For instance, the controller/processor 725 could support beam forming or directional routing operations in which outgoing/incoming signals from/to multiple antennas 712 and 714 are weighted differently to effectively steer the outgoing signals in a desired direction. Any of a wide variety of other functions could be supported in the transceiver 603 by the controller/processor 725.

The controller/processor 725 is also capable of executing programs and other processes resident in the memory 730, such as an OS and, for example, processes to a support or enable a reciprocal architecture of a reciprocal wireless transceiver for dual channel amplifier isolation as discussed in greater detail below. The controller/processor 725 can move data into or out of the memory 730 as required by an executing process.

The memory 730 is coupled to the controller/processor 725. Part of the memory 730 could include a RAM, and another part of the memory 730 could include a Flash memory or other ROM.

Although FIG. 7 illustrates one example of a transceiver 603, various changes may be made to FIG. 7. For example, transceiver 603 could include any number of each component shown in FIG. 7. Also, various components in FIG. 7 could be combined, further subdivided, or omitted and additional components could be added according to particular needs.

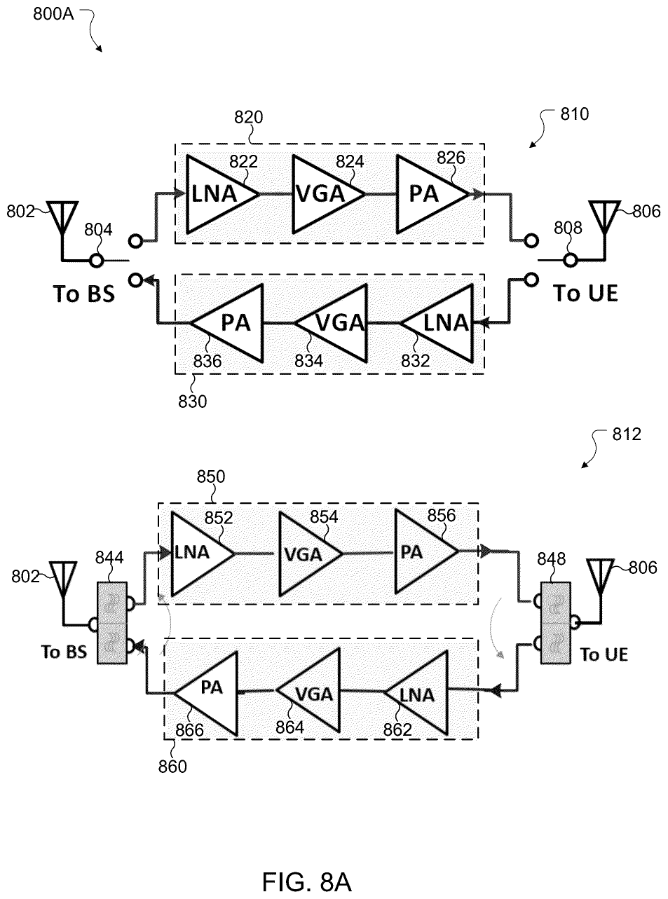

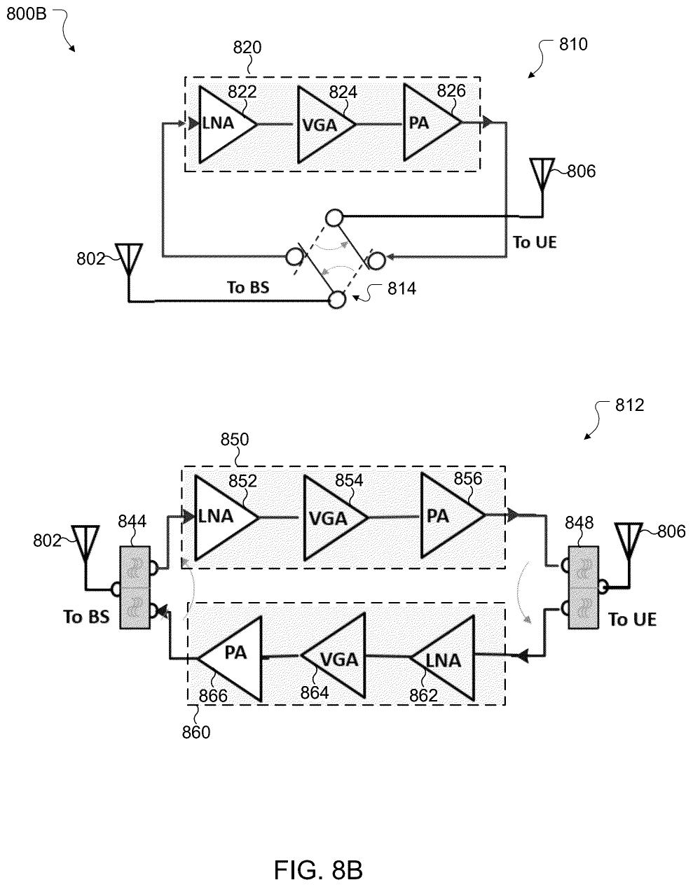

Signal transceivers, such as the transceiver 603, may employ various architectures. For example, the transceiver 603 could employ an architecture as shown in FIGS. 8A-8B.

FIGS. 8A-8B illustrate example wireless transceiver system architectures 800A, 800B according to embodiments of the present disclosure. In particular, FIG. 8A illustrates a wireless transceiver architecture 800A that includes two time division duplexing (TDD) amplifier chains and FIG. 8B illustrates a wireless transceiver architecture 800B that includes a single TDD amplifier chain. The embodiment of the wireless transceiver architectures 800A, 800B illustrated in FIGS. 8A-8B is for illustration only, other transceivers could have the same or similar configuration. However, transceivers come in a wide variety of configurations, and FIGS. 8A-8B do not limit the scope of this disclosure to any particular implementation of a transceiver.

As shown in FIG. 8A, the wireless transceiver architecture 800A includes a first antenna 802 and a second antenna 806, as well as a first transceiver 810 configured for time division duplexing (TDD) and a second transceiver 812 configured for frequency division duplexing (TDD). The first transceiver 810 includes a first TDD amplifier chain 820 and a second TDD amplifier chain 830. The second transceiver 812 includes a first FDD amplifier chain 850 and a second FDD amplifier chain 860. The wireless transceiver architecture 800A is configured to include a transmitter operating mode (e.g., a downlink mode) and a receiver operating mode (e.g., an uplink mode).

In the transmitter operating mode, a signal received from a base station (e.g., BS 602 of FIG. 6) via the first antenna 802 is amplified by the amplifier chain 820 of the first transceiver 810, which includes a TDD low noise amplifier (LNA) 822, a TDD variable gain amplifier (VGA) 824, and a TDD power amplifier (PA) 826. The signal is first amplified by the TDD LNA 822, and then by the TDD PA 826, which is optimized for maximum power transfer and power added efficiency. The VGA 824, inserted between the TDD LNA 822 and the TDD PA 826, is an optional component that may be used to tune the gain of amplifier chain 820. The repeated signal, which is several orders higher in power at the output of the TDD PA 826 is transmitted to a UE (e.g., UE 611 of FIG. 6) via the second antenna 806. Each of the TDD LNA 822, the TDD VGA 824, and the TDD PA 826 amplify the amplitude of the repeated signal before transmission using the second antenna 806.

Similarly, in the transmitter operating mode, the received signal from the first antenna 802 is amplified in the frequency domain using the first FDD amplifier chain 850 of the second transceiver 812, which includes an FDD low noise amplifier (LNA) 852, an FDD variable gain amplifier (VGA) 854, and an FDD power amplifier (PA) 856. Each of the FDD LNA 852, the FDD VGA 854, and the FDD PA 856 amplify the frequency of the repeated signal before transmission using the second antenna 806.

In the receiver operating mode, the signal direction is reversed. A signal received from a UE (e.g., UE 611 of FIG. 6) via the second antenna 806 is amplified by the amplifier chain 830 of the first transceiver 810, which includes a TDD low noise amplifier (LNA) 832, a TDD variable gain amplifier (VGA) 834, and a TDD power amplifier (PA) 836. The signal is first amplified by the TDD LNA 832, and then by the TDD PA 836, which is optimized for maximum power transfer and power added efficiency. The VGA 834, inserted between the TDD LNA 832 and the TDD PA 836, is an optional component that may be used to tune the gain of the amplifier chain 830. The repeated signal, which is several orders higher in power at the output of the TDD PA 836 is transmitted to a base station (e.g., gNB 602 of FIG. 6) via the first antenna 802.

In the receiver operating mode, the received signal from the second antenna 806 is amplified in the frequency domain using the second FDD amplifier chain 860 of the second transceiver 812, which includes an FDD LNA 862, an FDD VGA 864, and an FDD PA 866. Each of the FDD LNA 862, the FDD VGA 864, and the FDD PA 866 amplify the frequency of the repeated signal before transmission using the first antenna 802.

To select between the transmitter operating mode and the receiver operating mode, wireless transceiver architecture 800A includes a first TDD switch 804 coupled between the first antenna 802, the first TDD amplifier chain 820 and the second TDD amplifier chain 830 and a second TDD switch 808 coupled between the second antenna 806, the first TDD amplifier chain 820 and the second TDD amplifier chain 830. Each of the first TDD switch 804 and the second TDD switch 808 may be a single pole double throw (SPDT). Similarly, the wireless transceiver architecture 800B includes a first FDD duplexer 844 coupled between the first antenna 802, the first FDD amplifier chain 850, and the second FDD amplifier chain 860 and a second FDD duplexer 848 coupled between the second antenna 806, the first FDD amplifier chain 850, and the second FDD amplifier chain 860. The 804, the second TDD switch 808, the first FDD duplexer 844, and the second FDD duplexer 848 may be controlled by a processor (e.g., processor 725 of FIG. 7). During transmitter operating mode, the first TDD switch 804 is configured to switch the first antenna 802 into the input of the first TDD amplifier chain 820, and the second TDD switch 808 is configured to switch the second antenna 806 into the output of the first TDD amplifier chain 820. Concurrently, the first FDD duplexer 844 is configured to switch the first antenna 802 into the input of the first FDD amplifier chain 850, and the second FDD duplexer 848 is configured to switch the second antenna 806 into the output of the first FDD amplifier chain 850.

During receiver operating mode, the first TDD switch 804 is configured to switch the first antenna 802 into the output of the second TDD amplifier chain 830, and the second TDD switch 808 is configured to switch the second antenna 806 into the input of the second TDD amplifier chain 830. Concurrently, the first FDD duplexer 844 is configured to switch the first antenna 802 into the input of the second FDD amplifier chain 860, and the second FDD duplexer 848 is configured to switch the second antenna 806 into the output of the second FDD amplifier chain 860.

Similarly, as shown in FIG. 8B, the wireless transceiver architecture 800B includes the first transceiver 810 and the first TDD amplifier chain 820. However, the first transceiver 810 includes a single TDD amplifier chain (e.g., the first TDD amplifier chain 820) and a TDD switch 814. The single TDD switch 814 is a double pole double throw (DPDT) switch and is coupled between the first antenna 802, the second antenna 806, and the first TDD amplifier chain 820.

During the transmitter operating mode, the single TDD switch 814 is configured to switch the switch the first antenna 802 into the input of the first TDD amplifier chain 820 and switch the second antenna 806 into the output of the first TDD amplifier chain 820. During the receiver operating mode, the single TDD switch 814 is configured to switch the first antenna 802 into the output of the second TDD amplifier chain 830, and the second TDD switch 808 is configured to switch the second antenna 806 into the input of the second TDD amplifier chain 830.

The wireless transceiver architecture 800B and the wireless transceiver architecture 800B diversify the isolation of the TDD switches, the FDD duplexer, and the gain of amplifiers. Each transceiver (e.g., the first transceiver 810 and the second transceiver 812) is configured to bi-directionally amplify the signal from BTS to CPE or from CPE to BTS. The amplifier gain of each transceiver is less than the isolations of the TDD switches and the FDD duplexer, preventing self-oscillation and degradation of the SNR of the wireless transceiver architecture 800B and the wireless transceiver architecture 800B. In other words, the gain of the amplifier chain is limited, preventing signal leakage (e.g., between a received signal to the receiver amplifier chains during a transmitter operating mode or vice versa), which allows each transceiver to be stable.

Although FIGS. 8A-8B illustrates one example of a wireless transceiver architecture 800A and 800B, various changes may be made to FIGS. 8A-8B. For example, the wireless transceiver architectures 800A and 800B could include any number of each component shown in FIGS. 8A-8B. Also, various components in FIGS. 8A-8B could be combined, further subdivided, or omitted, and additional components could be added according to particular needs. For example, while the wireless transceiver architecture 800A includes a first TDD amplifier chain 820 and a second TDD amplifier chain 830, the first amplifier chain 820 and the second TDD amplifier chain 830 could be replaced with single amplifiers, amplifier groups, amplifier sets, or a combination thereof.

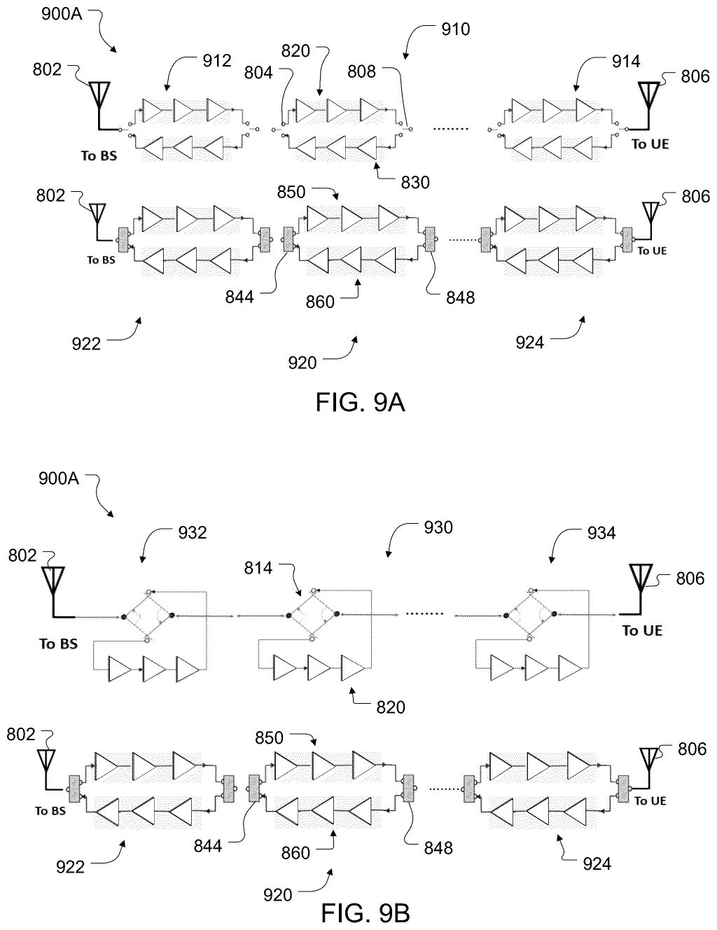

If more gain or more output power is required of the system, the transceiver architecture may include a cascade of multiple amplifier stages to achieve stability while meeting such gain or power requirements as shown in FIGS. 9A-9B.

FIGS. 9A-9B illustrate example cascaded transceiver architectures 900A and 900B according to embodiments of the present disclosure. For ease of explanation, the cascaded transceiver architecture 900A will be described as including one or more components of the wireless transceiver architecture 800A of FIG. 8A and the cascaded transceiver architecture 900B will be described as including one or more components of the wireless transceiver architecture 800B of FIG. 8B; however, the cascaded transceiver architectures 900A and 900B could be implemented using any other suitable device or system.

As shown in FIG. 9A, the cascaded transceiver architecture 900A includes the first transceiver 810 and the second transceiver 812. The first transceiver 810 includes a plurality of TDD amplifier stages 910. Each of the plurality of TDD amplifier stages 910 includes the first TDD switch 804, the second TDD switch 808, the first TDD amplifier chain 820, and the second TDD amplifier chain 830. A first end TDD amplifier stage 912 couples to the first antenna 802 and a second end TDD amplifier stage 914 couples to the second antenna 806. Similarly, the second transceiver 812 includes a plurality of FDD amplifier stages 920. Each of plurality of FDD amplifier stages 920 includes the first FDD duplexer 844, the second FDD duplexer 848, the first FDD amplifier chain 850, and the second FDD amplifier chain 860. A first end FDD amplifier stage 922 couples to the first antenna 802 and a second end FDD amplifier stage 924 couples to the second antenna 806.

As shown in FIG. 9B, the cascaded transceiver architecture 900B includes the first transceiver 810 and the second transceiver 812. The first transceiver 810 includes a plurality of TDD amplifier stages 930. Each of the plurality of TDD amplifier stages 930 includes the single TDD switch 814, the first TDD amplifier chain 820, and the second TDD amplifier chain 830. A first end TDD amplifier stage 932 couples to the first antenna 802 and a second end TDD amplifier stage 934 couples to the second antenna 806. Similarly, the second transceiver 812 includes a plurality of FDD amplifier stages 920. Each of the plurality of FDD amplifier stages 920 includes the first FDD duplexer 844, the second FDD duplexer 848, the first FDD amplifier chain 850, and the second FDD amplifier chain 860. A first end FDD amplifier stage 922 couples to the first antenna 802 and a second end FDD amplifier stage 924 couples to the second antenna 806.

Additionally, although three amplifier blocks or stages are shown, the plurality of FDD amplifier stages 920 may include N FDD amplifier stages where N is greater than 1, including the first end FDD amplifier stage 922 and the second end FDD amplifier stage 924 (e.g., the Nth FDD amplifier stage). The first end FDD amplifier stage 922 and the second end FDD amplifier stage 924 each include an FDD LNA capability and an FDD PA capability. The first end FDD amplifier stage 922 is configured to operate using the FDD LNA capability while refraining from operating using the FDD PA capability during a transmitter operating mode and operating using the FDD PA capability while refraining from operating using the FDD LNA capability during a receiver operating mode. The second end FDD amplifier stage is configured to operate using the FDD LNA capability while refraining from operating using the FDD PA capability during the receiver operating mode and operating using the FDD PA capability while refraining from operating using the FDD LNA capability during the transmitter operating mode.

The second transceiver 812 includes N duplexers, including the first FDD duplexer 844 and the second FDD duplexer 848, and the N duplexers are configured to cascade the N FDD amplifier stages such that the first end FDD amplifier stage 922 operates as an input to the second transceiver 812 and the second end FDD amplifier stage 924 operates as an output to the second transceiver 812. The N duplexers electrically couple the first antenna 802 to an input signal path of the first end FDD amplifier stage 922 and electrically couple the second antenna 806 to an output signal path of the second end FDD amplifier stage 924 during the transmitting operating mode. The N FDD amplifier stages are cascaded such that the second end FDD amplifier stage 924 operates as the input to the second transceiver 812 and the first end FDD amplifier stage 922 operates as the output to the second transceiver 812, electrically couple the first antenna 802 to the input signal path of the second end FDD amplifier stage 924, and electrically couple the second antenna 806 to the output signal path of the first end FDD amplifier stage 922 during the receiver operating mode.

The first transceiver 810 is configured to cascade similarly, where the pluralities of TDD amplifier stages 910, 930 include M TDD amplifier stages with 2M TDD switches 804, 808 (FIG. 9A) or M TDD switches 814 (FIG. 9B). Optionally, the number of TDD amplifier stages M need not match the number of FDD amplifier stages N.

The cascaded transceiver architecture 900A and the cascaded transceiver architecture 900B incorporate multiple cascaded amplifier stages to meet a total system gain requirement or goal. However, because the gain and isolation are diversified, the system will remain stable even with high gain demands. The only adjustment required to meet high gain demands using the cascaded transceiver architecture 900A or the cascaded transceiver architecture 900B are the noise factor and the 1 dB compression point (P1dB) specifications accomplished by selecting appropriate LNA and PA components.

Although FIGS. 9A-9B illustrate example cascaded transceiver architectures 900A and 900B, various changes may be made to FIGS. 9A-9B. For example, various changes to amplifier chain 920 could be made, antennas 902 and 904 could each be antenna arrays, etc. according to particular needs. For example, while FIGS. 9A-9B shows that the cascaded transceiver architecture 900A includes the plurality of FDD amplifier stages 920, each of the plurality of FDD amplifier stages 920 could be replaced with a single amplifier, an amplifier group, an amplifier set, or a combination thereof.

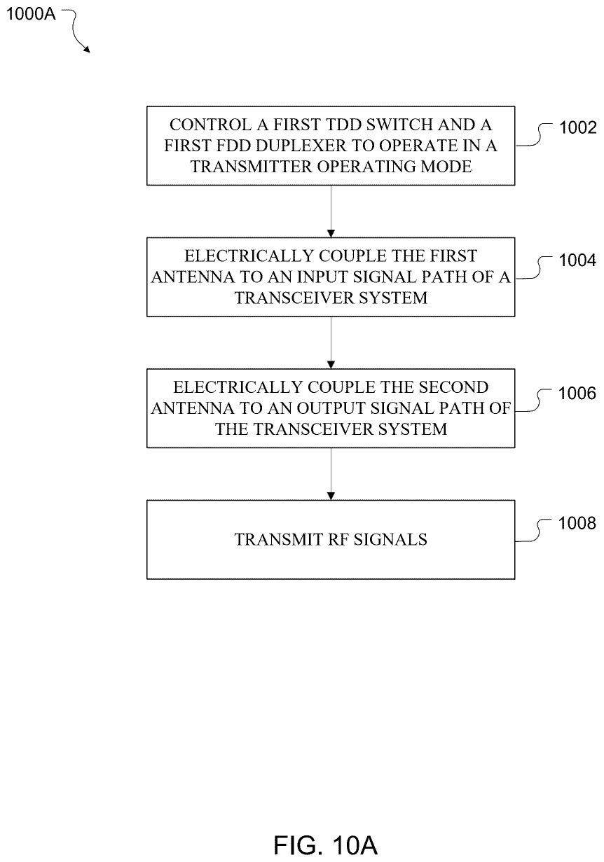

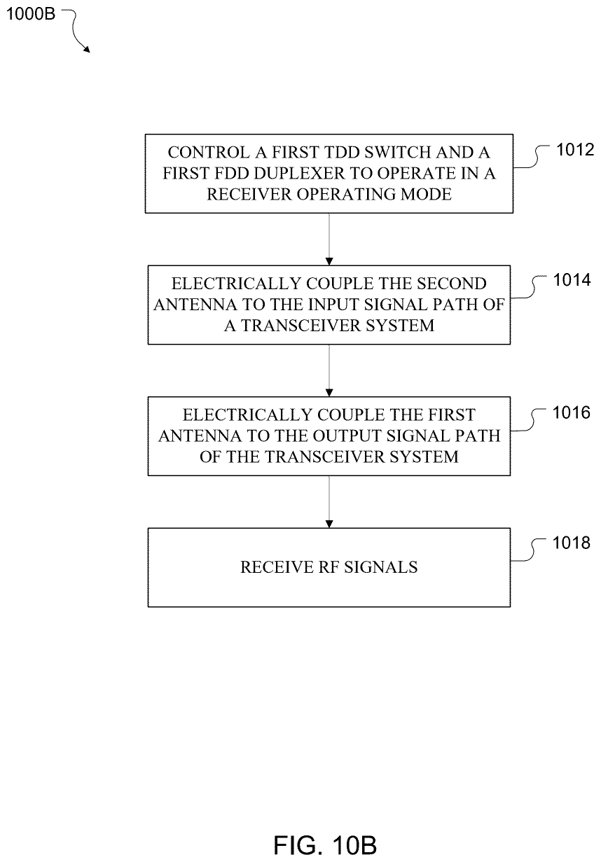

FIGS. 10A-10B illustrate example methods for operating a transceiver according to embodiments of the present disclosure. In particular, FIG. 10A illustrates an example method 1000A of operating a transceiver system in a transmitter mode and FIG. 10B illustrates an example method 1000B of operating a transceiver system in a receiver mode. The embodiment of the methods illustrated in FIGS. 10A-10B are for illustration only. One or more of the components illustrated in FIGS. 10A-10B may be implemented in specialized circuitry configured to perform the noted functions or one or more of the components may be implemented by one or more processors executing instructions to perform the noted functions. Other embodiments of a method for operating a transceiver could be used without departing from the scope of this disclosure.

As shown in FIG. 10A, a first TDD switch and a first FDD duplexer of a transceiver system are controlled to operate in a transmitter operating mode at step 1002. For example, the first TDD switch 804 and the first FDD duplexer 844 may be operated using a controller (e.g., the controller 725) coupled to the transceiver system architecture 800A.

A first antenna is electrically coupled to an input signal path of the transceiver system at step 1004. For example, the first antenna 802 may be coupled to an input signal path of the first TDD amplifier chain 820 of the first transceiver 810 using the first TDD switch 804 of the wireless transceiver architecture 800A. Alternatively, the first antenna 802 may be coupled to an input path of the first TDD amplifier chain 820 using the single TDD switch 814 of the wireless transceiver architecture 800B. Concurrently, the first antenna 802 may be coupled to an input signal path of the first FDD amplifier chain 850 of the second transceiver 812 using the first FDD duplexer 844.

A second antenna is electrically coupled to an output signal path of the transceiver system at step 1006. For example, the second antenna 806 may be coupled to an output signal path of the first TDD amplifier chain 820 of the first transceiver 810 using the second TDD switch 808. Alternatively, the second antenna 806 may be coupled to an output path of the first TDD amplifier chain 820 using the single TDD switch 814 of the wireless transceiver architecture 800B. Concurrently, the second antenna 806 may be coupled to an output signal path of the first FDD amplifier chain 850 of the second transceiver 812 using the second FDD duplexer 848.

RF signals are transmitted at step 1008. For example, a received signal from a BTS may be amplified using the first TDD amplifier chain 820 for TDD and amplified using the first FDD amplifier chain 850 for FDD to produce an amplified repeated signal. Further the first transceiver 810 and the second transceiver 812 may be part of the cascaded transceiver architecture 900A or the cascaded transceiver architecture 900B, such that the first transceiver 810 includes the plurality of TDD amplifier stages 910 and the second transceiver 812 includes the plurality of FDD amplifier stages 920. Alternatively, the first transceiver 810 may include the plurality of TDD amplifier stages 930. The amplified repeated signal is then transmitted to a UE (e.g., a CPE) using the second antenna 806.

As shown in FIG. 10B, a first TDD switch and a first FDD duplexer are controlled to operate in a receiver operating mode at step 1012. For example, the first TDD switch 804 and the first FDD duplexer 844 may be operated using a controller (e.g., the controller 725) coupled to the transceiver system architecture 800A.

A first antenna is electrically coupled to an output signal path of the first transceiver at step 1014. For example, the first antenna 802 may be coupled to an output signal path of the first TDD amplifier chain 820 of the first transceiver 810 using the first TDD switch 804 of the wireless transceiver architecture 800A. Alternatively, the first antenna 802 may be coupled to an output path of the first TDD amplifier chain 820 using the single TDD switch 814 of the wireless transceiver architecture 800B. Concurrently, the first antenna 802 may be coupled to an output signal path of the first FDD amplifier chain 850 of the second transceiver 812 using the first FDD duplexer 844.

A second antenna is electrically coupled to an input signal path of the second transceiver at step 1016. For example, the second antenna 806 may be coupled to an input signal path of the first TDD amplifier chain 820 of the first transceiver 810 using the second TDD switch 808. Alternatively, the second antenna 806 may be coupled to an input path of the first TDD amplifier chain 820 using the single TDD switch 814 of the wireless transceiver architecture 800B. Concurrently, the second antenna 806 may be coupled to an input signal path of the first FDD amplifier chain 850 of the second transceiver 812 using the second FDD duplexer 848.

RF signals are received at step 1018. For example, a received signal from a UE (e.g., a CPE) may be amplified using the second TDD amplifier chain 830 for TDD and amplified using the second FDD amplifier chain 860 for FDD to produce an amplified repeated signal. Further the first transceiver 810 and the second transceiver 812 may be part of the cascaded transceiver architecture 900A or the cascaded transceiver architecture 900B, such that the first transceiver 810 includes the plurality of TDD amplifier stages 910 and the second transceiver 812 includes the plurality of FDD amplifier stages 920. Alternatively, the first transceiver 810 may include the plurality of TDD amplifier stages 930. The amplified repeated signal is then sent to the BTS using the first antenna 802.

Although FIGS. 10A-10B illustrates example methods 1000A, 1000B for operating a transceiver system, various changes may be made to FIGS. 10A-10B. For example, while shown as a series of steps, various steps in FIGS. 10A-10B could overlap, occur in parallel, occur in a different order, occur any number of times, be omitted, or replaced by other steps.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A transceiver system comprising:
a first antenna configured to transmit and receive radio frequency (RF) signals from a base station (BS);
a second antenna configured to transmit and receive RF signals from a user equipment (UE);
a processor configured to control an operating mode of the transceiver system;
a first transceiver configured for time division duplexing (TDD) operatively coupled to the processor, the first transceiver comprising:
a first TDD amplifier stage; and
a first TDD switch; and
a second transceiver configured for frequency division duplexing (FDD) operatively coupled to the processor, the second transceiver comprising:
a first FDD amplifier stage; and
a first FDD duplexer.

2. The transceiver system of claim 1, wherein the first FDD duplexer is configured to:
electrically couple the first antenna to an input signal path of the second transceiver and electrically couple the second antenna to an output signal path of the second transceiver during a transmitter operating mode; and
electrically couple the second antenna to the input signal path of the second transceiver and electrically couple the first antenna to the output signal path of the second transceiver during a receiver operating mode.

3. The transceiver system of claim 1, wherein:
the second transceiver further comprises:
a second FDD amplifier stage; and
a second FDD duplexer;
the first FDD duplexer is configured to:
electrically couple an output signal path of the first FDD amplifier stage to an input signal path of the second FDD amplifier stage, and electrically couple the first antenna to an input signal path of the first FDD amplifier stage during a transmitter operating mode; and
electrically couple an output signal path of the second FDD amplifier stage to an input signal path of the first FDD amplifier stage, and electrically couple the first antenna to an output signal path of the first FDD amplifier stage during a receiver operating mode; and
the second FDD duplexer is configured to:
electrically couple an input signal path of the second FDD amplifier stage to an output signal path of the first FDD amplifier stage and electrically couple the second antenna to an output signal path of the second FDD amplifier stage during the transmitter operating mode; and
electrically couple an output signal path of the second FDD amplifier stage to an input signal path of the first FDD amplifier stage and electrically couple the first antenna to an input signal path of the second FDD amplifier stage during the receiver operating mode.

4. The transceiver system of claim 3, wherein each of the first FDD amplifier stage and the second FDD amplifier stage comprise:
an FDD low noise amplifier (LNA) including an input of the amplifier stage;
an FDD variable gain amplifier (VGA) including an input electrically coupled to an output signal path of the FDD LNA; and
an FDD power amplifier (PA) including an output of the amplifier stage and an input electrically coupled to an output signal path of the FDD VGA.

5. The transceiver system of claim 1, wherein:
the second transceiver comprises at least N FDD amplifier stages including the first FDD amplifier stage and an Nth FDD amplifier stage, where N is greater than 1;
the first FDD amplifier stage and the Nth FDD amplifier stage each include an FDD LNA capability and an FDD PA capability;
the first FDD amplifier stage is configured to:
operate using the FDD LNA capability while refraining from operating using the FDD PA capability during a transmitter operating mode; and
operating using the FDD PA capability while refraining from operating using the FDD LNA capability during a receiver operating mode;
the Nth FDD amplifier stage is configured to:
operate using the FDD LNA capability while refraining from operating using the FDD PA capability during the receiver operating mode; and
operating using the FDD PA capability while refraining from operating using the FDD LNA capability during the transmitter operating mode;
the second transceiver comprises N duplexers, including the first FDD duplexer; and
the N duplexers are configured to:
cascade the N FDD amplifier stages such that the first FDD amplifier stage operates as an input to the second transceiver and the Nth FDD amplifier stage operates as an output to the second transceiver, electrically couple the first antenna to an input signal path of the first FDD amplifier stage, and electrically couple the second antenna to an output signal path of the Nth FDD amplifier stage during the transmitting operating mode; and
cascade the N FDD amplifier stages such that the Nth FDD amplifier stage operates as the input to the second transceiver and the first FDD amplifier stage operates as the output to the second transceiver, electrically couple the first antenna to the input signal path of the Nth FDD amplifier stage, and electrically couple the second antenna to the output signal path of the first FDD amplifier stage during the receiver operating mode.

6. The transceiver system of claim 1, wherein the first TDD switch is configured to:
electrically couple the first antenna to an input signal path of the first transceiver and electrically couple the second antenna to an output signal path of the first transceiver during a transmitter operating mode; and
electrically couple the second antenna to the input signal path of the first transceiver and electrically couple the first antenna to the output signal path of the first transceiver during a receiver operating mode.

7. The transceiver system of claim 6, wherein the first TDD amplifier stage comprises:
a TDD low noise amplifier (LNA) including an input of the amplifier stage;
a TDD variable gain amplifier (VGA) including an input electrically coupled to an output signal path of the TDD LNA; and
a TDD power amplifier (PA) including an output of the amplifier stage and an input electrically coupled to an output signal path of the TDD VGA.

8. A method, comprising:
controlling a first TDD switch and a first FDD duplexer to operate a transceiver system in a transmitter operating mode or in a receiver operating mode, the transceiver system comprising:
a first antenna;
a second antenna;
a processor configured to control an operating mode of the transceiver system;
a first transceiver configured for time division duplexing (TDD) operatively coupled to the processor, the first transceiver comprising a first TDD amplifier stage and the first TDD switch; and
a second transceiver configured for frequency division duplexing (FDD) operatively coupled to the processor, the second transceiver comprising a first FDD amplifier stage and the first FDD duplexer; and
receiving or transmitting RF signals.

9. The method of claim 8, further comprising:
controlling the first TDD switch and the first FDD duplexer to operate a transceiver system in the transmitter operating mode, comprising:
using the first TDD switch to electrically couple the first antenna to an input signal path of the first transceiver and electrically couple the second antenna to an output signal path of the first transceiver; and
using the first FDD duplexer to electrically couple the first antenna to an input signal path of the second transceiver and electrically couple the second antenna to an output signal path of the second transceiver.

10. The method of claim 8, further comprising:
controlling the first TDD switch and the first FDD duplexer to operate a transceiver system in the receiver operating mode, comprising:
using the first TDD switch to electrically couple the second antenna to an input signal path of the first transceiver and electrically couple the first antenna to an output signal path of the first transceiver; and
using the first FDD duplexer to electrically couple the second antenna to the input signal path of the second transceiver and electrically couple the first antenna to the output signal path of the second transceiver.

11. The method of claim 8, wherein second transceiver further comprises:
a second FDD amplifier stage; and
a second FDD duplexer.

12. The method of claim 11, further comprising:
controlling a first TDD switch and a first FDD duplexer to operate a transceiver system in the transmitter operating mode, comprising:
using the first TDD switch to electrically couple the first antenna to an input signal path of the first transceiver and electrically couple the second antenna to an output signal path of the first transceiver;
using the first FDD duplexer to electrically couple the first antenna to an input signal path of the second transceiver and electrically couple the second antenna to an output signal path of the second transceiver; and
using the second FDD duplexer electrically couple an input signal path of the second FDD amplifier stage to an output signal path of the first FDD amplifier stage and electrically couple the second antenna to an output signal path of the second FDD amplifier stage.

13. The method of claim 11, further comprising:
controlling a first TDD switch and a first FDD duplexer to operate a transceiver system in the receiver operating mode, comprising:
using the first TDD switch to electrically couple the second antenna to an input signal path of the first transceiver, and electrically couple the first antenna to an output signal path of the first transceiver;
using the first FDD duplexer to electrically couple the second antenna to the input signal path of the second transceiver, and electrically couple the first antenna to the output signal path of the second transceiver; and
using the second FDD duplexer to electrically couple an output signal path of the second FDD amplifier stage to an input signal path of the first FDD amplifier stage and electrically couple the first antenna to an input signal path of the second FDD amplifier stage.

14. The method of claim 11, wherein each of the first FDD amplifier stage and the second FDD amplifier stage comprise:
an FDD low noise amplifier (LNA) including an input of the amplifier stage;
an FDD variable gain amplifier (VGA) including an input electrically coupled to an output signal path of the FDD LNA; and
an FDD power amplifier (PA) including an output of the amplifier stage and an input electrically coupled to an output signal path of the FDD VGA.

15. A non-transitory computer-readable medium comprising program code, that when executed by at least one processor of an electronic device, causes the electronic device to:
control a first TDD switch and a first FDD duplexer to operate a transceiver system of the electronic device in a transmitter operating mode or in a receiver operating mode, the transceiver system comprising:
a first antenna;
a second antenna;
a first transceiver configured for time division duplexing (TDD) and comprising a first TDD amplifier stage and the first TDD switch; and
a second transceiver configured for frequency division duplexing (FDD) and comprising a first FDD amplifier stage and the first FDD duplexer; and
receive or transmit RF signals.

16. The non-transitory computer-readable medium of claim 15, wherein the program code further comprises program code, that when executed by the at least one processor, causes the electronic device to:
control the first TDD switch and the first FDD duplexer to operate a transceiver system in the transmitter operating mode, comprising:
use the first TDD switch to electrically couple the first antenna to an input signal path of the first transceiver, and electrically couple the second antenna to an output signal path of the first transceiver; and
use the first FDD duplexer to electrically couple the first antenna to an input signal path of the second transceiver, and.

17. The non-transitory computer-readable medium of claim 15, wherein the program code further comprises program code, that when executed by the at least one processor, causes the electronic device to:
control the first TDD switch and the first FDD duplexer to operate a transceiver system in the receiver operating mode, comprising:
use the first TDD switch to electrically couple the second antenna to an input signal path of the first transceiver, and electrically couple the first antenna to an output signal path of the first transceiver; and
use the first FDD duplexer to electrically couple the second antenna to the input signal path of the second transceiver and electrically couple the first antenna to the output signal path of the second transceiver.

18. The non-transitory computer-readable medium of claim 15, wherein second transceiver further comprises:
a second FDD amplifier stage; and
a second FDD duplexer.

19. The non-transitory computer-readable medium of claim 18, wherein the program code further comprises program code, that when executed by the at least one processor, causes the electronic device to:
control the first TDD switch and the first FDD duplexer to operate a transceiver system in the transmitter operating mode, comprising:
use the first TDD switch to electrically couple the first antenna to an input signal path of the first transceiver, and electrically couple the second antenna to an output signal path of the first transceiver;
use the first FDD duplexer to electrically couple the first antenna to an input signal path of the second transceiver, and electrically couple the second antenna to an output signal path of the second transceiver; and
use the second FDD duplexer to electrically couple an input signal path of the second FDD amplifier stage to an output signal path of the first FDD amplifier stage and electrically couple the second antenna to an output signal path of the second FDD amplifier stage.

20. The non-transitory computer-readable medium of claim 18, wherein the program code further comprises program code, that when executed by the at least one processor, causes the electronic device to:
control the first TDD switch and the first FDD duplexer to operate a transceiver system in the receiver operating mode, comprising:
use the first TDD switch to electrically couple the second antenna to an input signal path of the first transceiver, and electrically couple the first antenna to an output signal path of the first transceiver;
use the first FDD duplexer to electrically couple the second antenna to the input signal path of the second transceiver, and electrically couple the first antenna to the output signal path of the second transceiver; and
use the second FDD duplexer to electrically couple an output signal path of the second FDD amplifier stage to an input signal path of the first FDD amplifier stage and electrically couple the first antenna to an input signal path of the second FDD amplifier stage.
